(19) United States
(12) Patent Application Publication
(10) Pub. No.: US 2002/0026766 A1
(43) Pub. Date: Mar. 7, 2002

(54) Construction method

(76) Inventor: John Wooster, Sydney (AU)

Correspondence Address: FULBRIGHT & JAWORSKI, LLP, 666 FIFTH AVE, NEW YORK, NY, 10103-3198, US

(21) Appl. No.: 09/735,747

(22) Filed: Dec. 13, 2000

Related U.S. Application Data
(63) Continuation of application No. 09/214,990, filed on May 10, 1999, now abandoned.
Application No. 09/214,990 is a 371 of international application No. PCT/AU97/00449, filed on Jul. 16, 1997.

(51) Int. Cl. E06B 3/54; E04B 9/00; E04C 2/34; E04B 1/00; E04G 21/00; E04G 23/00

(52) U.S. Cl. 52/741.1; 52/745.02; 52/745.05; 52/481.1; 52/479

(57) ABSTRACT

A construction method in which wall panel (2) receives studs (12) in apertures (8) or grooves (10). The studs (12) may be inserted through the wall panel after the wall panel is positioned. The studs (12) engage a bottom plate (20) in a snap fit.

### TECHNICAL FIELD

This invention relates to a construction method. This invention also relates to a pre-fabricated wall assembly.

### BACKGROUND ART

It is well known to build a frame for a wall. The frame consists of vertical studs and horizontal nogging. The cladding panels are then fixed, usually with nails, to the frame.

A problem with this known methodology is that it is time and labour intensive. Furthermore, this methodology requires an extensive use of tools and fixing components such as nails.

### DISCLOSURE OF INVENTION

This invention in one aspect resides in a construction method for a wall, the construction method including:

inserting a load bearing stud member through, or pre-locating a load bearing stud member in, a vertical aperture or groove defined in a wall panel; and

fixing the stud member relative to a substrate.

Whilst other types of engagement may be utilised, it is highly preferred that the stud member engages the substrate in a “snap fit”. As such, it will be appreciated that fully inserting a stud member through the aperture or groove of a positioned wall panel will result in the stud member being “automatically” fixed to the substrate. Equally, pre-located stud members will be “automatically” fixed to the substrate when the wall panel is positioned relative to the substrate.

In one embodiment the stud member is pre-located in the vertical aperture or groove and the positioning of the wall panel relative to the substrate also causes the fixing of the stud member relative to the substrate.

In another embodiment the stud member is fully inserted through the vertical aperture or groove in the wall panel after the wall panel is positioned relative to the substrate and wherein full insertion of the stud member also causes fixing of the stud member relative to the substrate.

One embodiment is a hybrid of the above two options in that the stud members for the grooves are pre-located in the grooves at the ends of the wall panel, however the stud member(s) for the aperture(s) are fully inserted into the aperture(s) subsequent to the wall panel being positioned. It is advantageous if the wall panel can be transported and handled on site without the additional weight of at least some of the stud members being pre-located in the wall panel.

It is preferred that fixing means adapted to fixedly engage the bottom of the stud member is fixed to the substrate. The fixing means may be discrete, however it is preferred that the fixing means extends continuously along the substrate and constitutes a bottom plate. It is also preferred that the fixing means receives the bottom of the stud member in a resilient snap fit. Preferably, the fixing means is a U-shaped channel and the distal ends of the flanges of the U-shaped channel are in-turned, and the bottom of the stud member includes outwardly extending barb means adapted to engage the in-turned distal ends of the flanges of the U-shaped channel.

It is preferred that the top of the stud member is adapted to fixedly engage a top plate. Preferably, the top plate extends continuously along the top of the wall. It is also preferred that the top plate receives the top of the stud member in a resilient snap fit. Preferably, the top plate is a U-shaped channel and the distal ends of the flanges of the U-shaped channel are in-turned, and the top of the stud member includes outwardly extending barb means adapted to engage the in-turned distal ends of the flanges of the U-shaped channel.

Preferably, the stud member is a channel section steel stud. In this case the stud member is adapted to receive a timber stud therein. The timber stud may support a door jamb or window jamb. The timber stud may terminate at a level below the top of the stud member and the timber stud may support a lintel or window frame.

Preferably, the wall panel is a sandwich construction. Preferably, the centre of the sandwich construction is expanded polystyrene or the like and the aperture or groove is formed in the expanded polystyrene by hot wire cutting or the like.

Preferably, the wall panel includes a horizontal groove in its bottom surface adapted to accommodate the fixing means. The wall panel may also include a groove in its top surface to accomodate the top plate.

Alternatively, the top plate may stand proud of the panel.

In another aspect the invention resides in a construction method for a wall, the construction method including:

positioning a wall panel having a vertical groove in each end thereof on a bottom plate, each vertical groove having fixed therein or receiving therein a stud member adapted to fixedly engage the bottom plate.

Preferably, the wall panel also includes a vertical aperture and the method further includes:

inserting a further stud member through the aperture to fixedly engage the bottom plate.

In another aspect the invention resides in a wall panel including:

a vertical aperture and/or groove adapted to receive a stud member, the vertical aperture and/or groove extending from the top to the bottom of the wall panel.

Preferably, the wall panel includes a groove at each end, the grooves each adapted to receive a stud member.

Preferably, the grooves each include a stud member fixed therein.

Preferably, the wall panel further includes an aperture adapted to receive a further stud member.

In another aspect the invention resides in a prefabricated wall assembly including:

a wall panel including an aperture and/or groove adapted to receive a stud member therethrough or therein;

fixing means adapted to be fixed to a floor and adapted to fixedly engage the bottom of the stud member;

a stud member adapted to be inserted through the aperture and/or groove in the wall panel or pre-located in the aperture and/or groove in the wall panel.

Preferably, the assembly further includes:

a top plate adapted to fixedly engage the top of the stud member.

Preferably, the fixing means constitutes a bottom plate.

### BRIEF DESCRIPTION OF DRAWINGS

In order that this invention may be more easily understood and put into practical effect, reference will now be made to the accompanying drawings which illustrate a preferred embodiment of the invention, wherein:

FIG. 1 is a plan view of a wall panel according to the invention;

FIG. 2 is a sectioned elevation view of a wall panel according to the invention together with enlarged detail;

FIG. 3 is a sectioned elevation view of a typical window head;

FIG. 4 is a sectioned plan view of a typical window jamb;

FIG. 5 is a sectioned elevation view of a typical window sill;

FIG. 6 is a sectioned elevation view of a wall/timber floor junction;

FIG. 7 is a sectioned elevation view of a wall/concrete floor junction;

FIG. 8 is a sectioned elevation view of another wall/concrete floor junction;

FIG. 9 is a sectioned elevation view of a typical lintel;

FIG. 10 is a sectioned elevation view of a typical full length window or door sill;

FIG. 11 is a perspective and sectioned elevation view of the stud/bottom plate connection;

FIG. 12 is a perspective and sectioned elevation view of a typical lintel;

FIG. 13 is an external perspective view of a corner;

FIG. 14 is a sectioned plan view of a corner panel;

FIG. 15 is a plan view of an internal wall panel;

FIG. 16 is a sectioned plan view of an internal angle connector;

FIG. 17 is a sectioned elevation view of a truss roof;

FIG. 18 is a sectioned elevation view of a typical gable end;

FIG. 19 is a sectioned elevation view of an internal wall and a series of sectioned plan views of door jambs;

FIG. 20 is a sectioned plan view of internal wall running perpendicularly to an external wall;

FIG. 21 is a sectioned plan view of a spandrel wall panel.

### BEST MODE

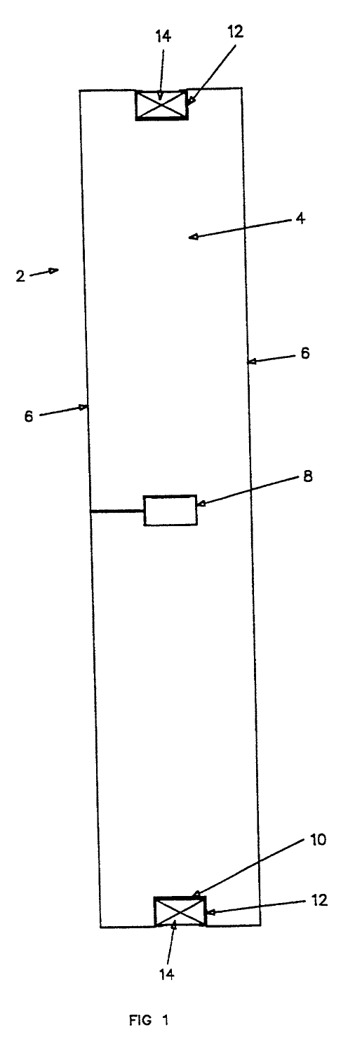

With reference firstly to FIG. 1, there is shown a plan view of a wall panel according to the invention. The wall panel is a sandwich construction consisting of a polystyrene core 4 and a more robust external laminate 6 such as plastic sheeting, fibro or gyprock which is glued to the core. Prior to the external laminates being applied to the polystyrene core, an aperture 8 is hotwire cut into the centre of the polystyrene core (the entry/exit of the hot wire is visible) and also grooves are hot-wire cut into the ends of the polystyrene core. As shown, channel-section studs 12 are pre-located in the grooves and timber studs 14 may be accomodated within the channel-section studs if required to support a lintel or the like.

Stud member 12 and timber stud 14 may be inserted through the aperture or located in the grooves on site when they are not already pre-located therein. The stud members may be inserted into the aperture and grooves at the factory or can be inserted on site. In the preferred system the stud members are fixed in the grooves at the factory and the stud member for the aperture is inserted into the aperture on site after the wall panel has been positioned. All timber studs can be inserted on site.

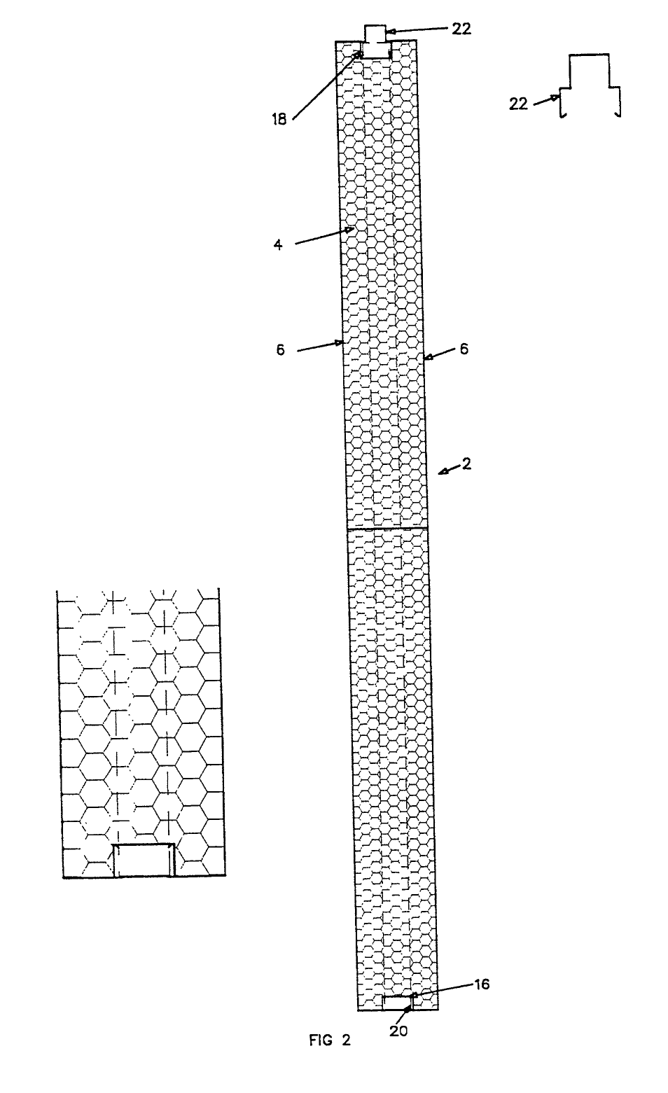

Turning now to FIG. 2 there is illustrated a sectioned elevation view of a wall panel 2. The wall panel is 2.4 m in height and consists of two 1.2 m high polystyrene cores 4 butted together. After the polystyrene cores have been butted together and the grooves and apertures have been hot-wired, the core is laminated to form the wall panel. It will be noted that the wall panel includes grooves 16, 18 hot-wire cut out of the bottom and top of the wall panel respectively. These channels are adapted to receive a bottom plate 20 and top plate 22 respectively. The top plate is also adapted to accomodate servicing. A stud member (shown in dotted line) extends between the bottom plate 20 and top plate 22. The stud member and bottom plate engage each other in a resilient snap fit as do the stud member and top plate. The top plate is shaped such that servicing can be routed along under the top plate.

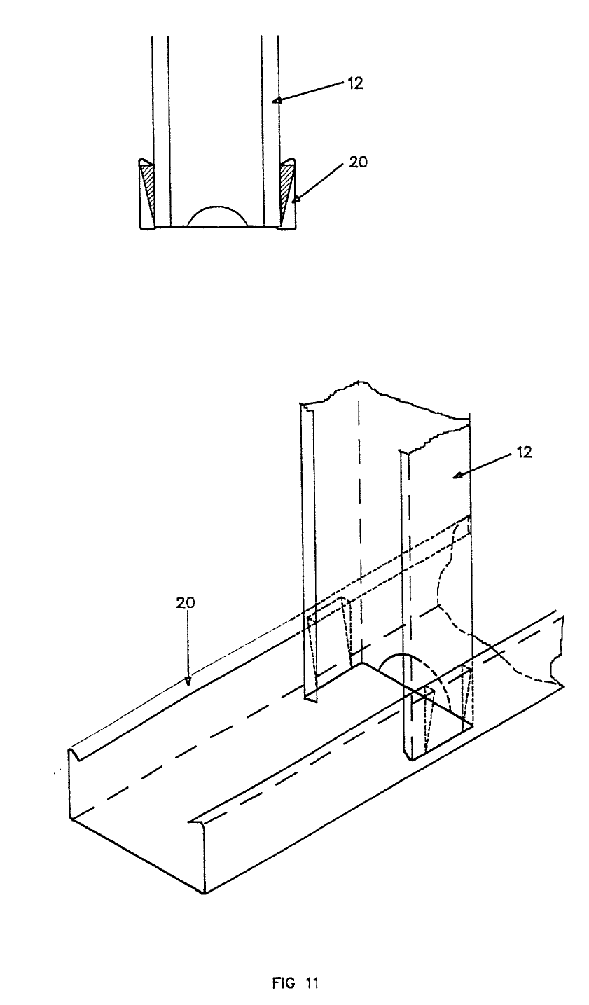

Referring now to FIG. 11, there is shown a perspective view of the stud member 12 being non-releasably engaged with the bottom plate 20. The bottom plate is a U-shaped channel with the distal ends of its flanges in-turned to engage wedges disposed on the external surface of the stud member. Thus, in use, the stud member is urged downwardly into engagement with the bottom plate and thereafter cannot move upwardly with respect to the bottom plate. The stud member is also restrained against rotation about the longitudinal axis of the bottom plate. It will be understood that the stud member can, however, be slid along the length of the bottom plate thereby facilitating positioning of the wall panel. Because the stud member is encased in the polystyrene core it cannot rotate about a horizontal axis transverse to the longitudinal axis of the bottom plate. Thus, once the stud member is fixed, the wall panel is substantially stabilised but can still be slid along the bottom plate.

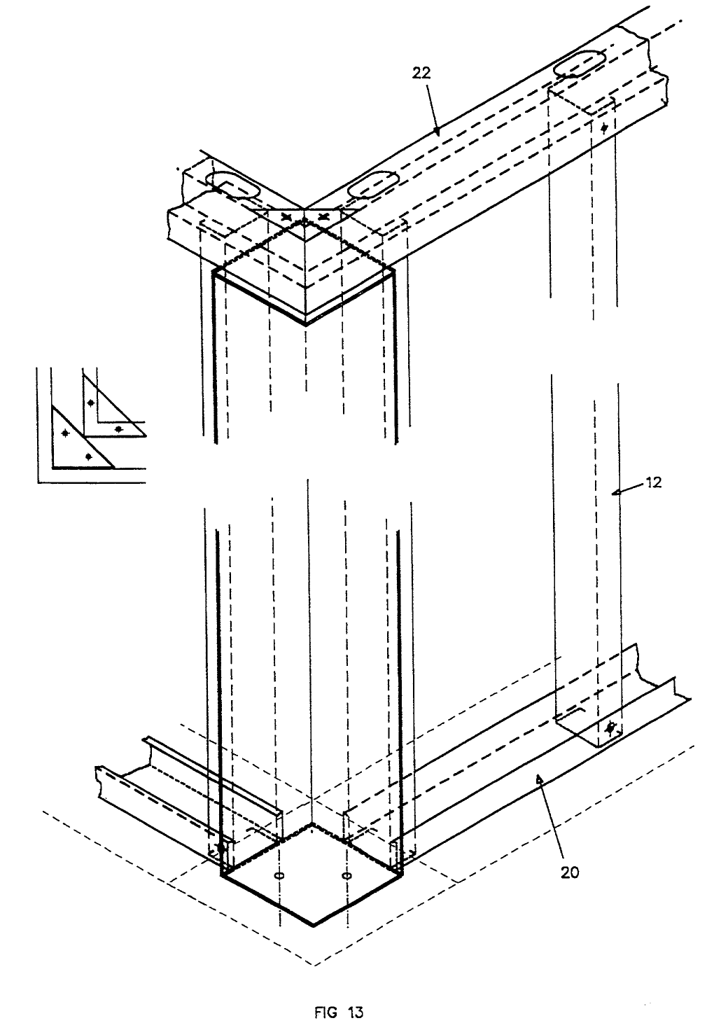

Referring now to FIG. 13 there is illustrated an external perspective view of a corner. As can be seen the bottom plates extend away from the corner. The lower end of the stud member 12 engages the bottom plate 20 in a snap fit, and the top plate 22 is located on the upper end of the stud member in a snap fit.

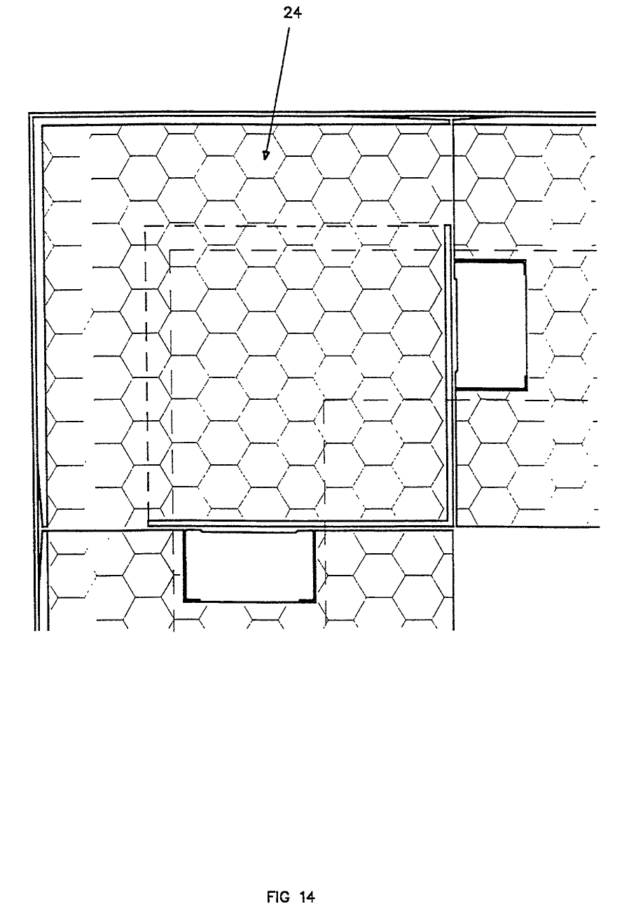

Referring now to FIG. 14 there is illustrated a sectioned plan view of a corner panel 24. The corner panel is square in plan section and is fixed in position on the substrate. The corner panel may include a corner stud extending through an aperture in the corner panel. In this regard, the corner stud is screw fixed to the bottom plate and thereafter the corner panel is slid downwardly over the corner post. Wall panels can then be positioned and supported by the corner panel.

The wall panel includes stud members located in the grooves at the ends of the wall panel. The channel shaped stud member in the groove constitutes a female member adapted to receive a serrated male member which is fixed to the surface of the corner panel (the corner panel is coated in a 2 mm thick 2 part polyurethane which takes the fixing of the male member). Thus, the positioning of the wall panel with respect to the corner panel is done in two components. One of the components is a horizontal movement whereby the stud member located in the groove in the end of the wall panel is engaged with the male member protruding from the surface of the corner panel. The other component is a downward movement of the wall panel whereby the bottom ends of the stud members engage the bottom plate. These two components of the positioning may be done in either order.

Alternatively, the stud member may be provided on the corner panel and the wall panel, with its vacant groove may be located such the the stud member occupies the groove in the wall panel.

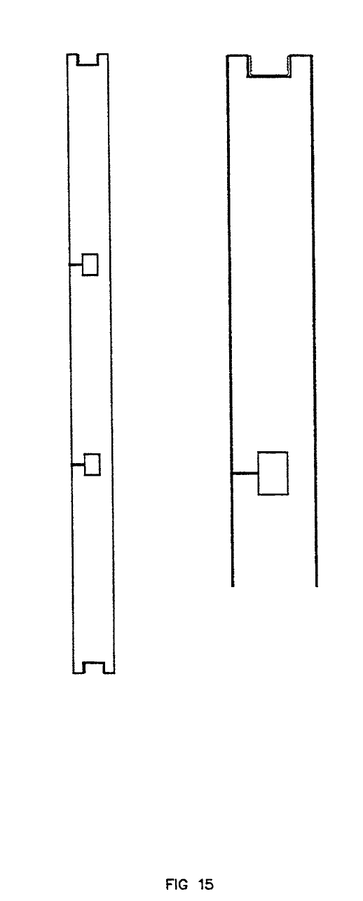

Referring now to FIG. 15 there is shown an internal non-load bearing wall panel. In this case, the grooves in the ends of the wall panel do not accommodate a stud member. Rather, they accommodate a serrated female member which is adapted to receive a male member as previously described. Furthermore, the aperture which is cut in the wall panel does not receive stud member but is provided for the purpose of allowing the ducting of services such as plumbing and electricity. To install the internal wall panel, a bottom plate is first fixed to the floor. The next step is to fix the male member to the external wall panel whch the internal wall panel abuts. The internal wall panel is then placed over the bottom plate (not fixed to the bottom plate as the internal wall panel does not have studs), and slid toward the male member until the male member engages the female member. The internal wall panel can be screw fixed to the bottom plate if necessary (alternatively the internal wall panel can include studs which engage the bottom plate).

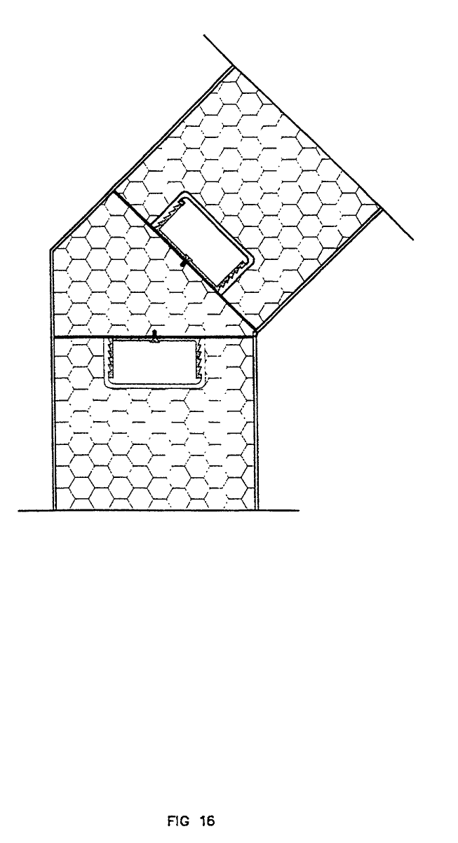

Referring to FIG. 16 there is shown a pair of internal wall panels connected to an angle connector. The angle connector includes a pair of serrated male members which are adapted to be received in the serrated female members disposed in the grooves cut in the ends of the internal wall panel.

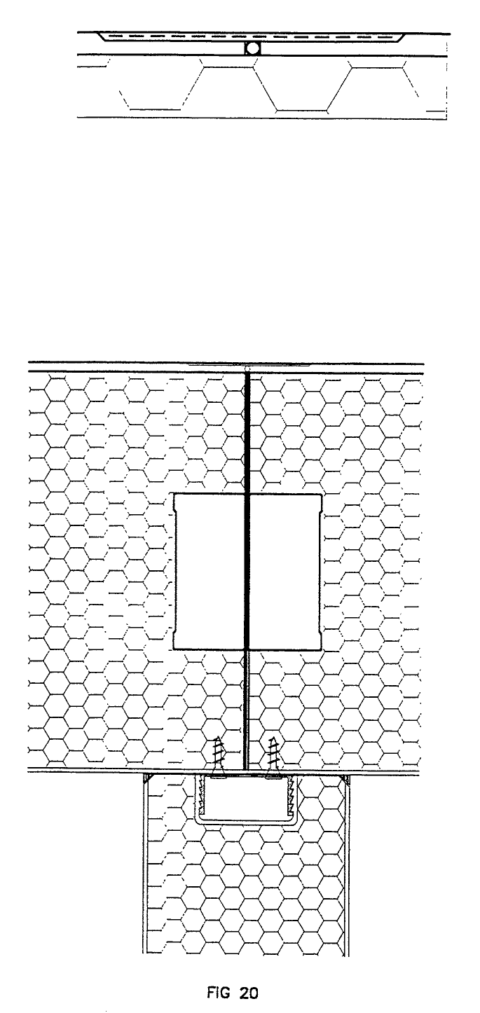

Referring to FIG. 20 there is shown an internal wall panel which is butt joined in “IT” configuration to an external load bearing wall. In this case the serrated male member is screwed to the surface of the load bearing external wall.

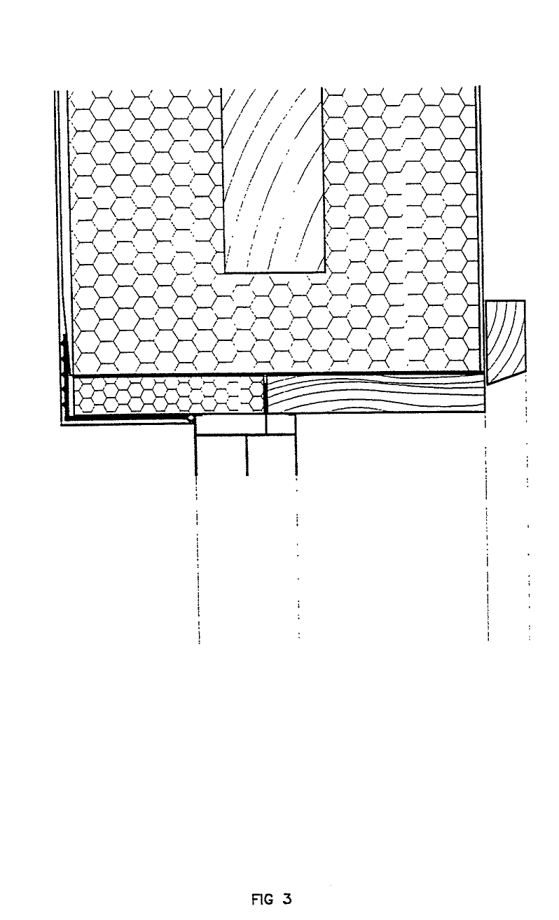

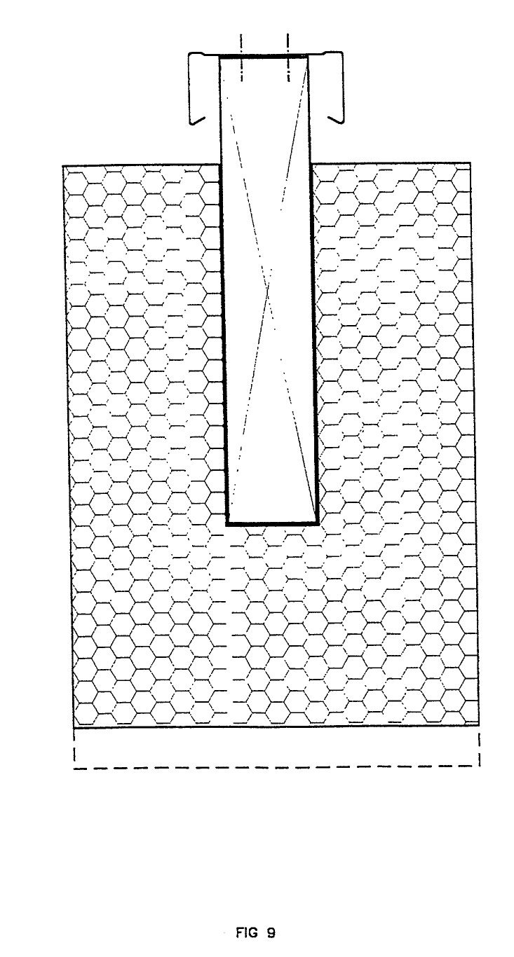

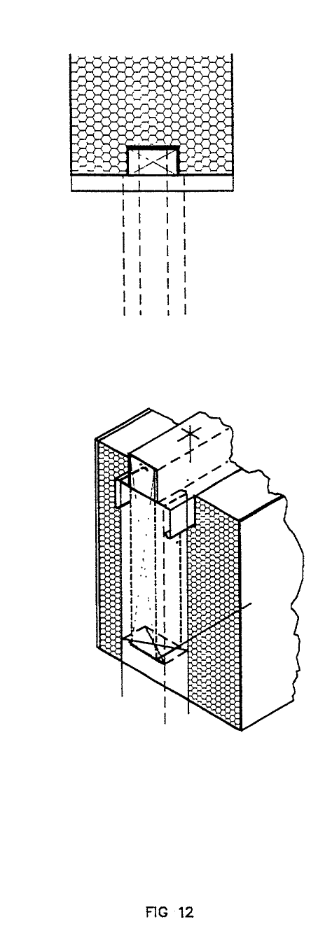

Referring now to FIG. 3, there is shown a sectioned elevation view of a typical window head. The construction of the window head illustrated in FIG. 3 has similarities to the typical lintel illustrated in FIGS. 9 and 12. In this regard a lintel extends between the adjacent studs and the top plate receives the top of the lintel as shown in FIGS. 9 and 12 (the top plate is nailed to the lintel at 500 mm centres). The lintel is supported by the adjacent studs. Particularly, timber studs are inserted inside the U-shaped channel steel studs and the timber studs terminate at the appropriate height. The lintel then sits on top of the ends of the timber studs. The sides and bottoms of the lintel are encased in an expanded polystyrene lintel panel. In the case of a window head as illustrated in FIG. 3, the reveal lining and architrave are fixed to the expanded polystyrene lintel section or panel.

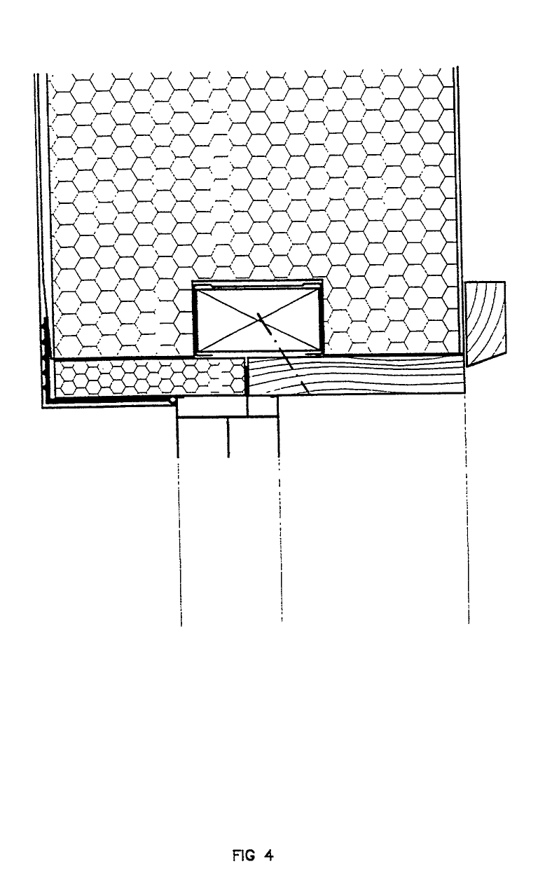

With reference to FIG. 4, there is shown a sectioned planned view of a typical window jamb. In this case the reveals are fixed to the timber stud which is inserted inside the channel steel stud. It will be recalled that the timber studs on adjacent sides of the window also support the overhead lintel.

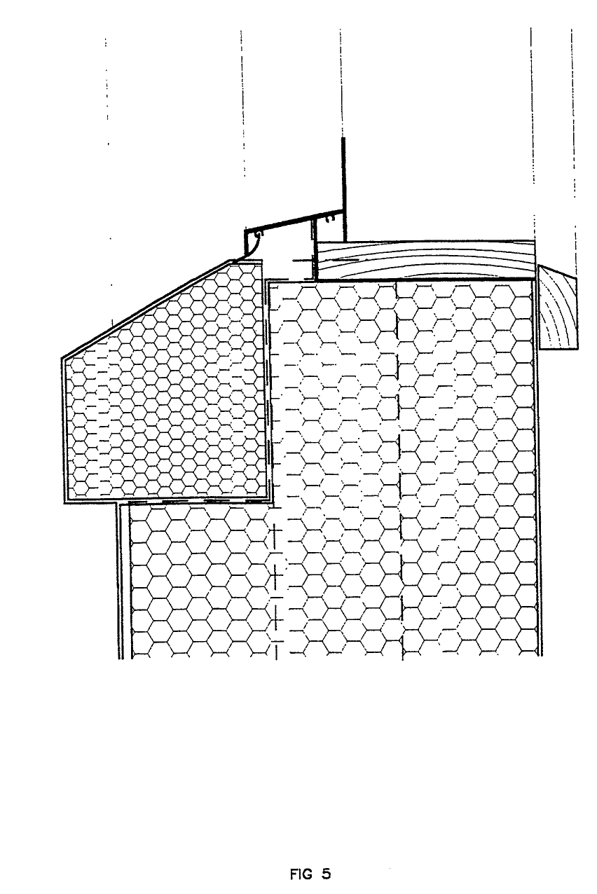

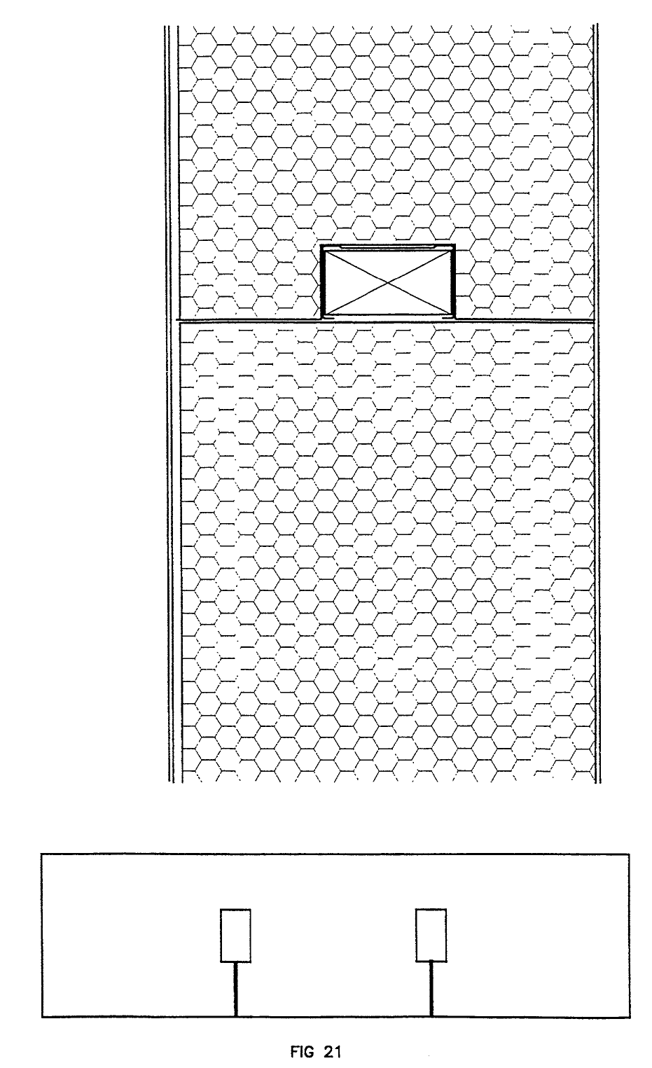

Referring now to FIG. 5 there is shown a typical window sill. A shortened wall panel (a spandrel panel) is disposed under the window sill and it will be recalled that this wall panel includes grooves disposed in its ends and also apertures, depending on the length of the wall panel. Timber studs are inserted in the grooves at the ends of the wall panel and these timber studs support the window sill. A spandrel panel is better illustrated in FIG. 21. Referring to FIG. 21, it will be noted that the wall panel adjacent the spandrel panel includes a steel stud and a timber stud inserted inside the steel stud. The timber stud extends to the height of the lintel above the window and the lintel extends between the tops of the timber studs. The spandrel panel itself is fixed relative to the wall panel by a male member which is fixed to the timber stud which engages the (short) steel stud disposed in the groove in the end of the spandrel panel. The steel stud in the spandrel panel supports the window frame. The bottom end of the steel stud engages the bottom plate in a resilient snap fit.

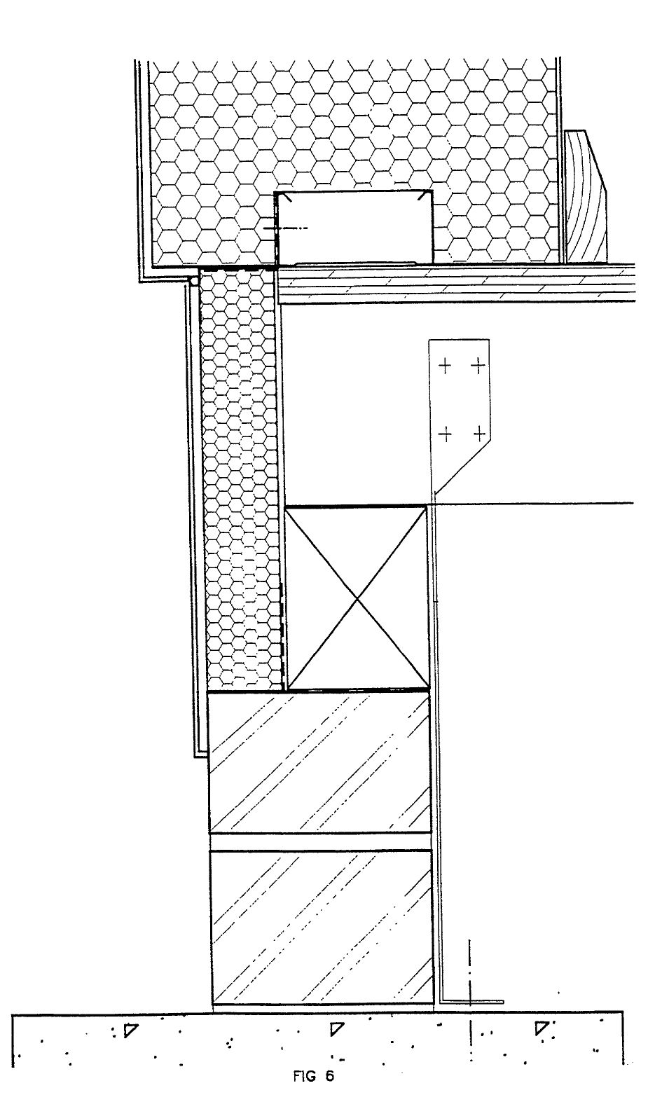

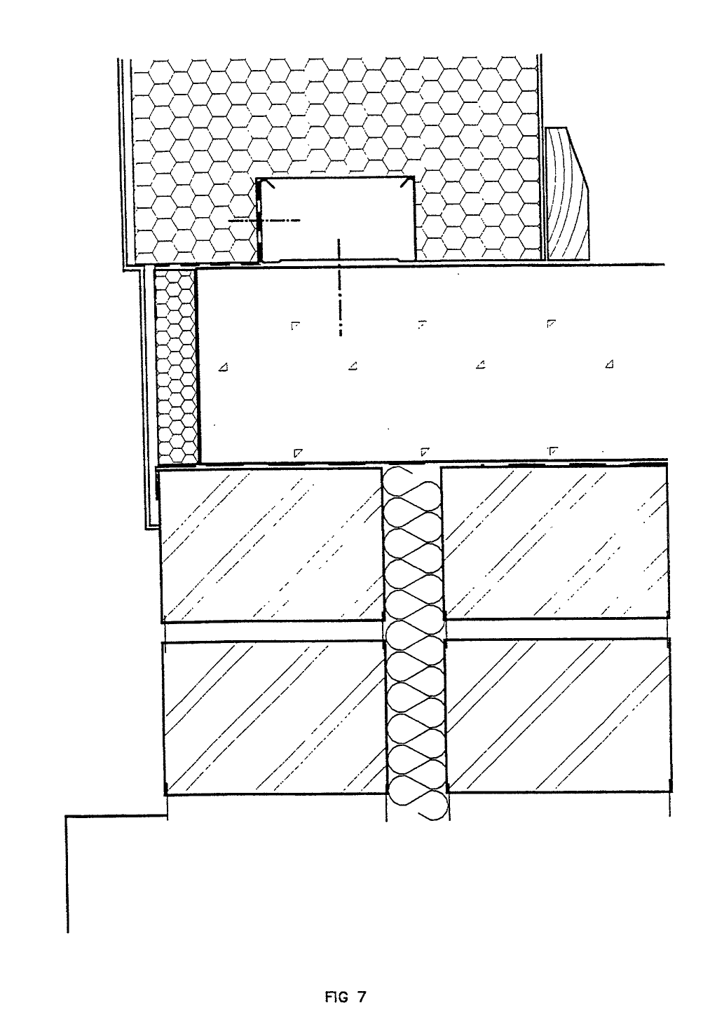

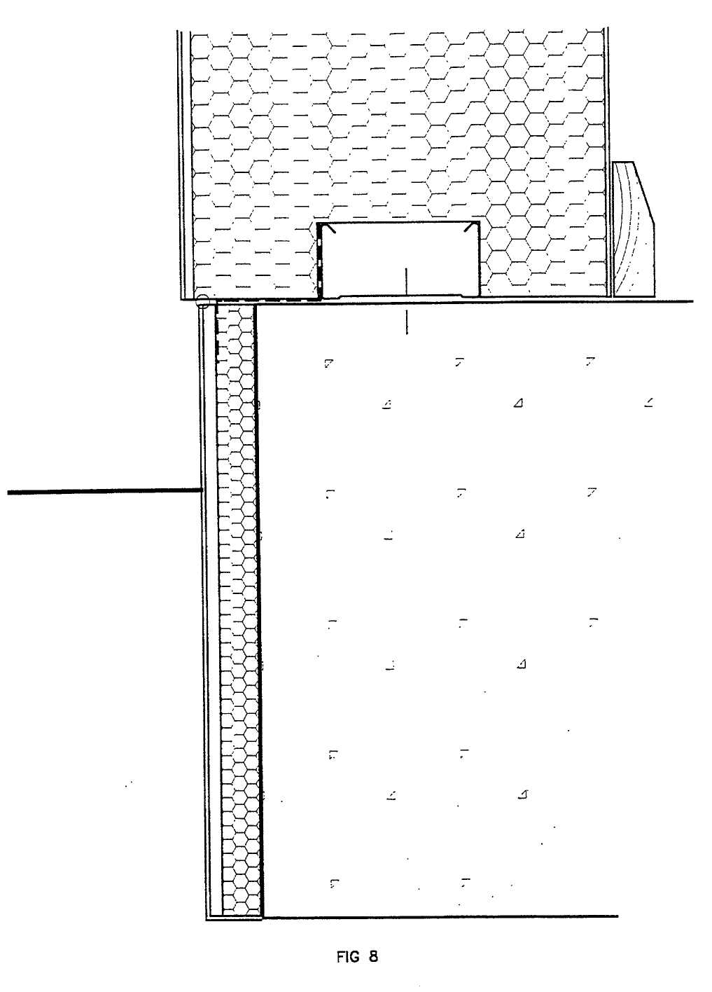

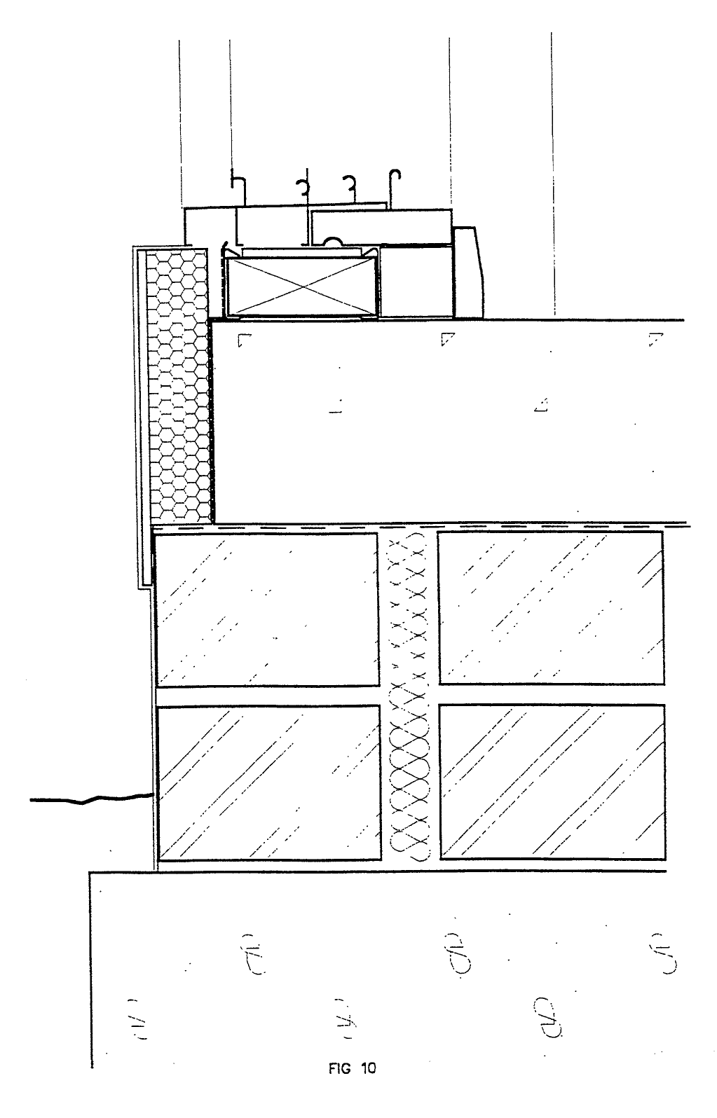

Referring now to FIGS. 6, 7, 8 and 10 there are illustrated various floor constructions. The floor construction per se does not form part of the invention. In all cases the bottom plate is fixed to the floor and thereafter the wall panels are positioned over the bottom plate and the stud members are fixed to the bottom plate.

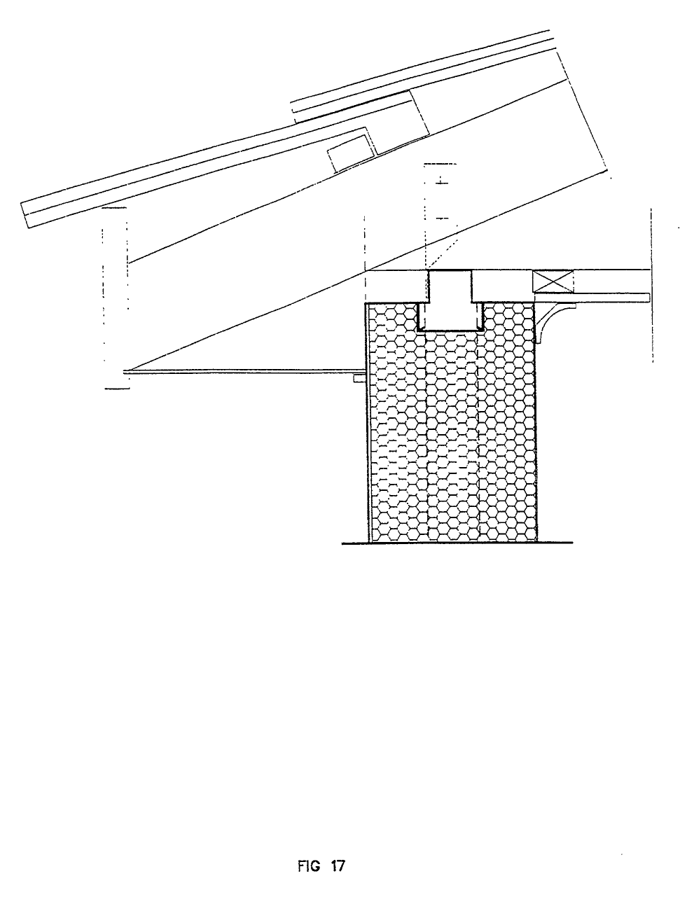

Referring now to FIG. 17 there is illustrated a typical truss roof. It will be noted that the stud member extends above the top of the wall panel. The truss bears on the top of the top plate in the normal manner.

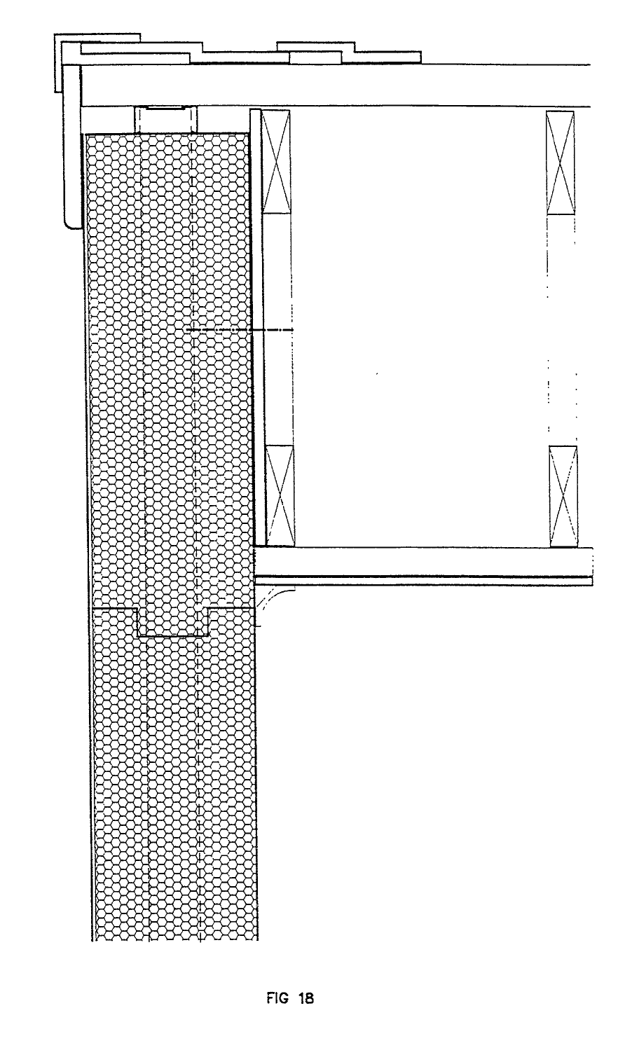

Referring now to FIG. 18 there is illustrated a typical gable end. In this case the stud member extends up through the gable as illustrated. A top plate receives the top ends of the studs but, due to the raking, requires mechanical fixing.

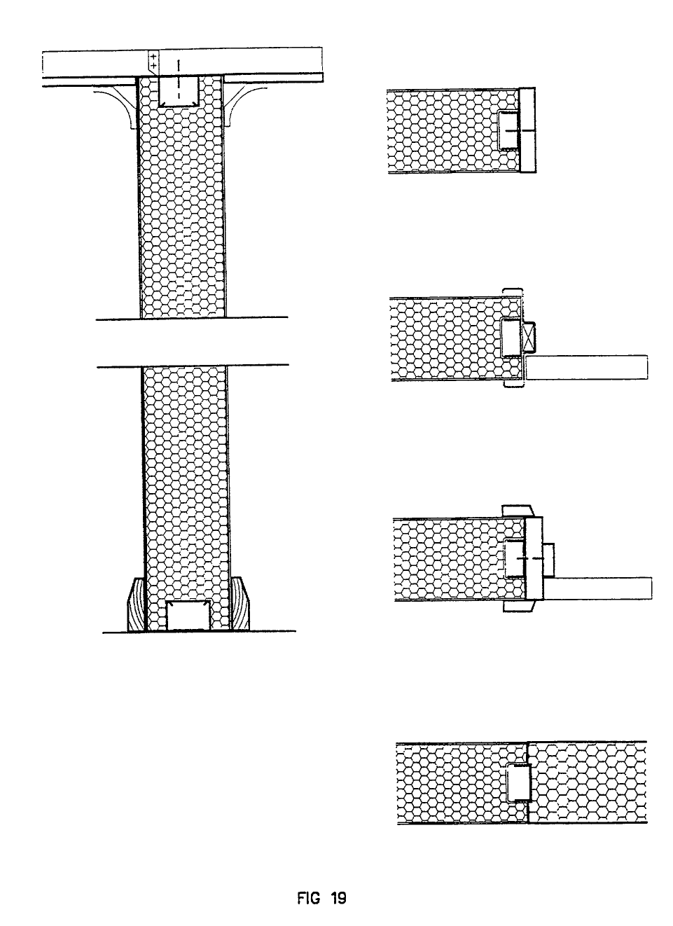

Referring now to FIG. 19, there is illustrated a sectioned elevation view of an internal wall. It will be noted that skirting boards are fixed to the bottom of the wall panel which is seated on a bottom plate in the manner previously described. The top plate may be fixed to the ceiling batten and with the assistance of a locating bracket.

Also shown in FIG. 19 are examples of door jambs. The door jambs include a male member which is adapted to be received in the female member which is constituted or accommodated by the groove in the end of the wall panel. Normally, the female member will be the stud member which is accomodated in the groove.

In general, construction of a wall is as follows:

Firstly the substrate is prepared. The bottom plate is fixed to the substrate and defines a track around the perimeter of the house. A corner post together with its corner panel are then screw fixed to the bottom plate in one corner of the house. Thereafter wall panels can be positioned appropriately relative to the corner panel with stud members being inserted through the grooves and apertures to fix the stud members to the bottom plate and hence fix the wall panels also. As previously noted, the stud members may already be inserted or pre-located in the wall panel or may be inserted after the wall panel has been positioned. Each wall panel is only discontinued at a doorway or window. That is, if a particular wall of a house does not have a door or window, then that wall will be comprised of a single wall panel which extends from corner post to corner post. The windows and doors are constructed as discussed above and the top plate is fitted onto the tops of the stud members. The roof or upper floor can be mounted on the top plate.

The present invention provides a system which is quick and easy to build. The present invention requires minimum use of tools and fixing components such as nails.

Some of the benefits of the system are as follows:

highly insulated panels

external walls have load bearing capacity

panels are delivered the full length of the required wall

panel can be computer hot-wire manufactured and laminated

no on-site waste

sub-trades can install services after preliminary construction

pre-finished panel surfaces ready for painting

high impact resistant skin materials

recyclable core and internal skin materials

fast and precise installation using minimal tools

simple to renovate and add on to

easily repairable wall surfaces

internal skin is able to take direct fixing of fixtures and fittings by screw or nailgun

major technical advancements without increasing costs to the end user

user friendly

constant quality finish

the ability to place structural framing members within the sandwich panel and provide snap connection

fully metric dimensioned building system

highly suitable for use in remote areas

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

The claims defining the invention are as follows:

1. A construction method for a wall, the construction method including:
inserting a load bearing stud member through, or pre-locating a load bearing stud member in, a vertical aperture or groove defined in a wall panel; and
fixing the stud member relative to a substrate.

2. A construction method as claimed in claim 1, wherein the stud member engages the substrate in a “snap fit”.

3. A construction method as claimed in claim 1, wherein the stud member is pre-located in the vertical aperture or groove and the positioning of the wall panel relative to the substrate also causes the fixing of the stud member relative to the substrate.

4. A construction method as claimed in calim 1, wherein the stud member is fully inserted through the vertical aperture or groove in the wall panel after the wall panel is positioned relative to the substrate and wherein full insertion of the stud member also causes fixing of the stud member relative to the substrate.

5. A construction method as claimed in claim 1, wherein fixing means adapted to fixedly engage the bottom of the stud member is fixed to the substrate.

6. A construction method as claimed in claim 5, wherein the fixing means extends continuously along the substrate and constitutes a bottom plate.

7. A construction method as claimed in claim 5, wherein the fixing means is a U-shaped channel and the distal ends of the flanges of the U-shaped channel are in-turned, and the bottom of the stud member includes outwardly extending barb means adapted to engage the in-turned distal ends of the flanges of the U-shaped channel.

8. A construction method as claimed in claim 1, wherein the top of the stud member is adapted to fixedly engage a top plate.

9. A construction method as claimed inclaim 8, wherein the top plate receives the top of the stud member in a resilient snap fit.

10. A construction method as claimed in claim 9, wherein the top plate is a U-shaped channel and the distal ends of the flanges of the U-shaped channel are in-turned, and the top of the stud member includes outwardly extending barb means adapted to engage the in-turned distal ends of the flanges of the U-shaped channel.

11. A construction method for a wall, the construction method including:
positioning a wall panel having a vertical groove in each end thereof on a bottom plate, each vertical groove having fixed therein or receiving therein a stud member adapted to fixedly engage the bottom plate.

12. A construction method as claimed in claim 11, wherein the wall panel also includes a vertical aperture and the method further includes:
inserting a further stud member through the aperture to fixedly engage the bottom plate.

13. A pre-fabricated wall assembly including:
a wall panel including an aperture and/or groove adapted to receive a stud member therethrough or therein;
fixing means adapted to be fixed to a floor and adapted to fixedly engage the bottom of the stud member;
a stud member adapted to be inserted through the aperture and/or groove in the wall panel or pre-located in the aperture and/or groove in the wall panel.
